(19) United States
(12) Patent Application Publication
(10) Pub. No.: US 2005/0213648 A1
(43) Pub. Date: Sep. 29, 2005

(54) Symmetric ADSL communication

(75) Inventor: Peter S. Chow, Los Altos, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/810,371

(22) Filed: Mar. 26, 2004

(51) Int. Cl. H04B 1/38

(52) U.S. Cl. 375/222

(57) ABSTRACT

A digital subscriber line (DSL) system including a central office (CO) switch (2) and a customer premises equipment (CPE) DSL modem (12), in which asymmetric DSL communications are implemented in a symmetric manner, is disclosed. Two twisted-wire pairs (10A, 10B) at the CPE are used to each carry ADSL traffic into and out of the modem (12). The CPE DSL modem (12) includes two transceiver functions (25R, 25C), with one transceiver (25C) communicating signals over its twisted-pair (10B) in a complementary manner relative to the signals on the other twisted-pair (10A). The combination of the two ADSL links provides symmetric data rates for the upstream and downstream directions.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of digital communications, and is more specifically directed to digital subscriber line (DSL) communications.

A popular modem technology for providing high-speed Internet access to homes and businesses is referred to as digital subscriber line (DSL). DSL communications permit high data rate digital communications between a modulator/demodulator (“modem”) at the customer premises and a modem at the telephone company “central office”, over existing twisted-pair copper telephone lines. Accordingly, DSL services can be installed at relatively low cost, in premises that are already being served by the telephone company. The primary limitation on locations that can receive DSL services is the distance from the premises to the nearest central office.

In conventional DSL communication, the signals being transmitted are modulated according to the important and now popular Discrete Multitone (DMT) modulation standard. In DMT modulation, the available spectrum is subdivided into many subchannels (e.g., 256 or more subchannels of 4.3125 kHz each). Each subchannel is centered about a carrier frequency that is phase and amplitude modulated, typically by Quadrature Amplitude Modulation (QAM), in which each symbol value is represented by a point in the complex plane. The number of available symbol values for each subchannel, and thus the number of bits in each symbol communicated over that subchannel, is determined during initialization of the DMT communications session. The number of bits per symbol for each subchannel (i.e., the “bit loading”) is determined according to the signal-to-noise ratio (SNR) at the subchannel frequency, which is affected by the transmission channel noise and the signal attenuation at that frequency. For example, relatively noise-free and low attenuation subchannels may communicate data in ten-bit to fifteen-bit symbols, represented by a relatively dense QAM constellation with short distances between points in the constellation. On the other hand, noisy channels may be limited to only two or three bits per symbol, allowing a greater distance between adjacent points in the QAM constellation. DMT modulation thus maximizes the data rate over each subchannel, permitting high speed access to be carried out even over relatively noisy and attenuated twisted-pair lines.

Various standards have been adopted regarding the definition of the available spectrum for DSL communications, the assignment of subchannels within that spectrum and the power spectral density (PSD) (i.e., the “frequency plan”). These standards also typically define the procedures for initiation, control, and maintenance of a DSL communication between modems. These standards, and also proposed standards or approaches, include various classes of asymmetric DSL (including “ADSL”; “ADSL2”; “ADSL2+”; and so-called “splitterless” DSL, which is also referred to as “G.lite”), very high-speed DSL (“VDSL”), high-bit-rate DSL (“HDSL”), and others.

The most widespread DSL technology, at least currently in the United States and Japan, is ADSL. The most popular implementation of ADSL follows a frequency-division multiplexing (FDM) approach, in that “downstream” communications from the central office (“CO”) to customer premises equipment (“CPE”) are in one frequency band of the spectrum, and “upstream” communications from the CPE to the CO are in another, non-overlapping, frequency band. ADSL can also be implemented in an echo-cancelled mode, where the downstream frequency band overlaps the upstream frequency band. However, this so-called “overlapped mode” of operation is not widely deployed. In either case, the asymmetry suggested by the acronym “ADSL” refers to the wider and higher-frequency band that is assigned to downstream communications, relative to the narrower, lower-frequency, upstream band. As a result, the ADSL downstream data rate is typically much greater than the upstream data rate, except in those cases in which the loop length is so long that the downstream frequency band becomes mostly unusable.

FIG. 1 illustrates the power spectrum allocation for conventional ADSL communications, such as carried out according to the G.992.1 standard entitled “Asymmetric digital subscriber line (ADSL) transceivers”, promulgated by the International Telecommunications Union. According to this allocation, the lowest frequencies are reserved for voice band telephony, or “plain old telephone service (“POTS”); as shown in FIG. 1, frequency band POTS occupies the frequencies from DC to about 4 kHz. A guard band region is present between 4 kHz and 25.875 kHz, so that ADSL communications can be carried on the same twisted pair wires as POTS, with only relatively modest filtering being necessary to prevent significant interference. The upstream ADSL communications (CPE to CO) are assigned to the frequency band US in FIG. 1, occupying the frequencies from 25.875 kHz to 138 kHz. The DMT modulation carries these upstream communications in thirty-two subchannels within frequency band US, each of 4.3125 kHz bandwidth. Downstream communications (CO to CPE) are assigned to higher-frequency and wider frequency band DS of FIG. 1, extending in this example from 138 kHz to 1.104 MHz as shown. According to the conventional ADSL standard, downstream communications are assigned 256 subchannels, each also having a bandwidth of 4.3125 kHz.

The FDM approach illustrated in FIG. 1 for conventional ADSL has been quite successful, and has been deployed on a widespread basis. A significant advantage provided by this conventional ADSL approach is the elimination of so-called near-end crosstalk (“NEXT”), which refers to interference in signals received at a transceiver from other co-located transceivers providing similar services over the same transmission frequency. Because the upstream and downstream transmissions are in separate frequency bands, as shown in FIG. 1, NEXT at both the CO and CPE for ADSL is insignificant.

As evident from FIG. 1, the downstream data rate is much higher than that of the upstream data rate in conventional ADSL. By design, the downstream data rate can be as high as eight times that of the upstream data rate; in typical use (considering typical bit allocations for the various subchannels), the downstream data rate is on the order of six times that of the upstream data rate. This directional asymmetry in data rates was originally selected based on the belief that much of the demand for ADSL services would be for high data rate services, such as video-on-demand (VoD), in which the subscriber would view movies and other high data-rate content supplied from the service provider from the central office to the customer premises (i.e., in the downstream direction). It was further contemplated that upstream ADSL communications would tend to be quite limited, primarily text-based email, web browsing commands, and ordering information for video-on-demand.

In recent years, however, it has become apparent that the ratio of downstream transmission demand to upstream demand may not be near the multiplier (e.g., 8:1) on which the ADSL standard is based. One reason for this is that video-on-demand has not become a significant service in recent years. In addition, many ADSL subscribers upload significant content, for example by way of multimedia emails, personal Internet web pages with links to home movies and sound files, and participation in file-sharing activities (including the notorious peer-to-peer file sharing of music files). Current estimates indicate that the demand for downstream data is somewhere between five times to about twice that of the upstream demand, depending on the operator.

However, the installed base of ADSL transceiver equipment, both at the central office and at customer premises is arranged according to the conventional frequency plan of FIG. 1. It would be extremely difficult and costly to now implement a different frequency plan (e.g., to redeploy current downstream subchannels and spectrum space as upstream subchannels), in order to better balance the upstream and downstream data rates with current demand.

By way of further background, DSL approaches that provide symmetric data rates and capacities, between upstream and downstream, are known. These known approaches include Integrated Services Digital Network (ISDN), T1 lines (according to ANSI standard T1.403), HDSL, symmetric DSL (SDSL), symmetric HDSL (SHDSL), and VDSL in its symmetric mode. By way of still further background, the “bonding” of DSL services is also known. An example of such bonding includes the bonding of four wire pairs for transmission in the same direction (i.e., so-called “4 pair HDSL”). A summary of conventional DSL technology is provided in Kerpez, Standardized DSL Spectrum Management (Telcordia Technologies, Inc., 2002), currently available at http://net3.argreenhouse.com:8080/dsl-test/Help/SM_paper.pdf.

By way of further background, DSL communications systems are known in which a “curb-side box” interfaces with the subscriber over twisted-pair copper wire, and communicates with the central office by way of a fiber optic facility, in the context of a “fiber-to-the-curb” implementation. According to one conventional realization, which is believed to be available from Critical Telecom Corp., the curb-side box includes analog-to-digital conversion circuitry, so that the DMT modulated signals communicated between the central office and curb-side box are in the digital domain.

### BRIEF SUMMARY OF THE INVENTION

It is therefore an object of this invention to provide a system and method of symmetric DSL communications using conventional ADSL transceivers.

It is a further object of this invention to provide such a system and method in which crosstalk is managed to permit symmetric DSL over adjacent wire pairs.

It is a further object of this invention to provide such a system and method in which existing infrastructure can be utilized.

Other objects and advantages of this invention will be apparent to those of ordinary skill in the art having reference to the following specification together with its drawings.

The present invention may be implemented by the incorporation of an asymmetric DSL (“ADSL”) “central office” transceiver at the customer premises equipment into an existing ADSL installation, to provide a “reverse” complementary ADSL communications link. The existing “forward” ADSL link and the “reverse” ADSL link operate on adjacent pairs of wires that are physically bonded to one another within a binder or binder group, for example extending from the customer premises to a nearby cross-connect cabinet, service area concentrator, or the like. These pairs are preferably dedicated to a single service provider, enabling crosstalk mitigation schemes to be applied to the forward and reverse ADSL links. High data rate DSL service that is more symmetric between the upstream and downstream directions is thus provided.

### BRIEF DESCRIPTION OF THE SEVERAL VIEWS OF THE DRAWING

FIG. 1 is a plot of power density versus frequency, illustrating a conventional asymmetric DSL (“ADSL”) frequency plan.

FIGS. 2A through 2C are electrical diagrams, in block form, of DSL communications systems constructed according to preferred embodiments of the invention.

FIGS. 3A and 3B are frequency plans for complementary ADSL communications according to the preferred embodiment of the invention.

FIG. 4 is an electrical diagram, in block form, of a DSL modem in customer premises equipment (CPE), constructed according to the preferred embodiment of the invention.

FIG. 5 is an electrical diagram, in block form, of DSL transceivers in a cross-connect switch at the cross-connect cabinet, constructed according to the preferred embodiment of the invention.

FIG. 6 is an electrical diagram, in block form, of a service area concentrator in the system of FIG. 2, constructed according to the preferred embodiment of the invention.

### DETAILED DESCRIPTION OF THE INVENTION

The present invention will be described in connection with its preferred embodiment, namely as implemented into a communications system in which conventional asymmetric DSL (“ADSL”) communications are carried out. It is contemplated that the invention is particularly beneficial when applied to such an example. However, it is also contemplated that this invention will also be useful in other types of communications systems. Accordingly, it is to be understood that the following description is provided by way of example only, and is not intended to limit the true scope of this invention as claimed.

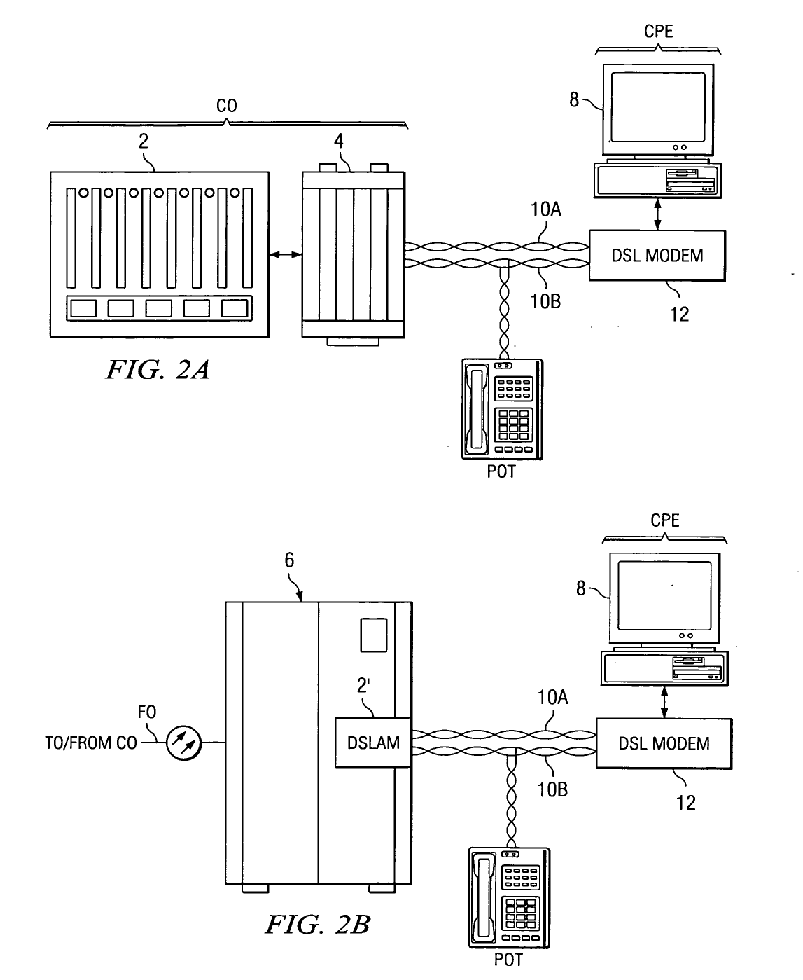

Specifically, FIGS. 2A through 2C illustrate various system implementations according to the preferred embodiment of the invention. It is contemplated that those skilled in the art having reference to this specification will recognize still further alternative realizations to these examples of FIGS. 2A through 2C. Accordingly, it is understood that those alternative implementations are within the scope of this invention as claimed.

Referring first to FIG. 2A, the exemplary communications system illustrated corresponds to twisted-pair DSL systems, in which the communications facility is twisted-pair copper wire over the entire length of the loop between central office CO and customer premises equipment CPE. In this example, two pairs 10A, 10B of twisted-pair copper wire constitute the communications facility. As known in the art, there may be additional network elements, termination locations, and the like inserted in the subscriber loop, and as such twisted-pairs 10A, 10B are typically not realized by contiguous wire.

As well known in the art, the central office (or “CO”) refers to a facility that is operated by a local telephone company as a common carrier switching center in which subscriber lines, trunks, and loops are terminated and switched. Accordingly, central office CO of FIG. 2A includes cross-connect switch 2, which effects the switching, terminating, and interconnecting of subscriber lines, trunks, and loops in the conventional manner. According to this embodiment of the invention, modulator/demodulator (“modem”) functionality is preferably implemented at cross-connect switch 2, for modulating outgoing signals from baseband into the appropriate DMT ADSL signals, and for demodulating received DMT signals back into baseband. In this modern communications system, central office CO also contains transmitter/receiver 4, which applies signals to and receives signals from twisted-pairs 10A, 10B as shown.

As known in the art, most home and office telephone customer installations have been implemented using a four-wire facility, arranged as two twisted-pairs such as pairs 10A, 10B of FIG. 2A. Conventional telephony, and indeed conventional ADSL communications, use one of these two pairs, with the other twisted pair remaining unused. According to the preferred embodiment of the invention, as will become apparent from the following description, both twisted-pairs 10A, 10B are used to carry asymmetric DSL (“ADSL”) traffic between central office CO and customer premises equipment CPE, but in a symmetric manner. In addition, as shown in FIG. 2A, one of these pairs (e.g., twisted-pair 10B) is coupled to conventional telephone POT at the customer premises, for carrying out POTS.

The customer premises equipment (CPE) deployed at the customer premises includes DSL modem 12, which is coupled to twisted-pairs 10A, 10B. Customer computer 8 is connected to DSL modem 12 directly, or by way of a local network at the customer location, in the conventional manner. Customer computer 8 is thus a common source of data to be transmitted over twisted-pairs 10A, 10B, and a common destination of data received over twisted-pairs 10A, 10B.

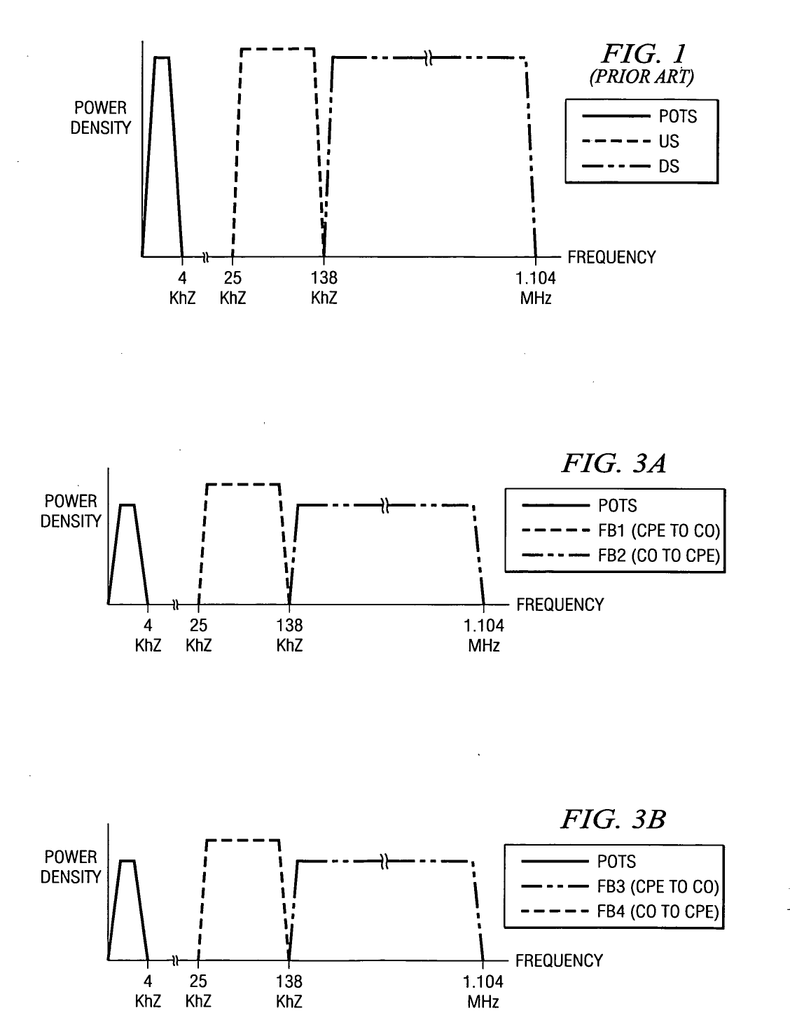

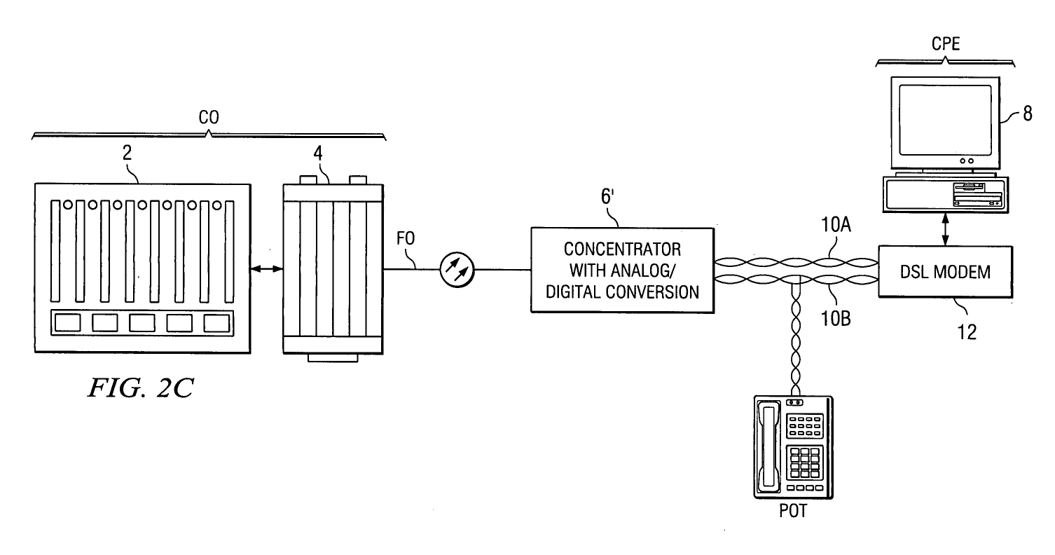

According to the preferred embodiment of the invention, ADSL communications are carried out between cross-connect switch 2 at central office CO and CPE DSL modem 12 on one twisted-pair (e.g., twisted-pair 10A) in the conventional manner, utilizing frequency division multiplexing (FDM). On twisted-pair 10A, in this example, downstream communications from central office CO to CPE DSL modem 12 are carried by frequency band FB2, which includes a large number of subchannels (e.g., 256 subchannels, according to conventional G.992.1 ADSL) at frequencies above 138 kHz, while upstream communications from CPE DSL modem 12 to central office CO occupy frequency band FB1, which includes a smaller number of subchannels (e.g., thirty-two subchannels, according to conventional G.992.1 ADSL), at frequencies between POTS communications and the upper frequency limit of 138 kHz. The frequency plan for ADSL communications over twisted-pair 10A is shown in FIG. 3A; this plan corresponds to conventional ADSL communications as described above relative to FIG. 1.

Detailed descriptions of the particular coding, decoding, modulation, demodulation, filtering, and other operations involved in ADSL communications, according to the preferred embodiment of the invention, are provided in U.S. Pat. No. 5,400,322; U.S. Pat. No. 5,596,604; U.S. Pat. No. 6,269,154 B1; U.S. Pat. No. 5,627,863; U.S. Pat. No. 6,009,122; U.S. Pat. No. 5,519,731; U.S. Pat. No. 5,673,290; and U.S. Pat. No. 5,680,394; all such patents owned by Texas Instruments Incorporated, and incorporated herein by this reference.

To obtain symmetric DSL communications, however, ADSL communications are also carried out between central office CO and CPE DSL modem 12 on second twisted-pair 10B. On twisted-pair 10B, however, the directions of transmission are reversed in the frequency plan from those carried by twisted-pair 10A. Preferably, the modulation approach, including the assignment of subchannels and the frequencies of the subchannels, on twisted-pair 10B is identical to that of the modulation on twisted-pair 10A, except for the reversal of the direction of transmission. An example of the frequency plan for ADSL communications on second twisted-pair 10B, according to this preferred embodiment of the invention, is illustrated in FIG. 3B. In this example, the high-frequency, higher data rate frequency band FB3 on twisted-pair 10B carries transmissions in the upstream direction from CPE DSL modem 12 toward central office CO, and the lower-frequency, lower data rate frequency band FB4 on twisted-pair 10B carries transmissions in the downstream direction from central office CO to CPE DSL modem 12. As evident from a comparison of FIGS. 3A and 3B to one another, the frequency plan is effectively identical, except that the upstream and downstream spectra are reversed. POTS need not be carried out on both of twisted-pairs 10A, 10B, and as such the POTS bandwidth is optional on one of the twisted pairs (in this case, twisted-pair 10A, as telephone POT is connected to twisted-pair 10B).

In the physical sense, twisted-pairs 10A, 10B are preferably “bonded” to one another. This bonding refers to the placement of twisted-pairs 10A, 10B in close proximity to one another over the length of their run from CPE DSL modem 12 to transceiver 4 at central office CO. Typically, this bonding is realized by placing twisted-pairs 10A, 10B into the same physical “binder” or “binder group” as one another. As known in the art, a “binder” refers to a collection of twisted pair wires that share a common “sheath.” Because of the proximity of wires sharing the sheath, conventional communication services carried out over the wires within a binder group preferably consider the effect of crosstalk and other interference among those services.

In this example, the DSL communications on twisted-pairs 10A, 10B are symmetric, at least theoretically. Downstream communications from central office CO to CPE DSL modem 12 will have a total data rate corresponding to the sum of that provided by the higher data rate frequency band FB2 of FIG. 3A over twisted-pair 10A and that provided by the lower data rate frequency band FB4 of FIG. 3B over twisted-pair 10B, while upstream communications from CPE DSL modem 12 to central office CO will have a total data rate corresponding to the sum of that provided by the higher data rate frequency band FB3 of FIG. 3B over twisted-pair 10B and that provided by the lower data rate frequency band FB1 of FIG. 3A over twisted-pair 10A. Assuming equivalent channel conditions on twisted pairs 10A, 10B, these sums will be substantially equal to one another. Symmetric bidirectional communications between central office CO and CPE DSL modem 12 will thus result.

Alternatively, the upstream and downstream data rates on twisted-pairs 10A, 10B need not be exactly symmetric, or exactly complementary, as in the case described above relative to FIGS. 3A and 3B. For example, a lesser degree of asymmetry may be desired. This may be implemented, for example, by assigning a frequency plan to the “reverse” ADSL facility over twisted-pair 10B that provides higher data rates for upstream communications relative to downstream communications, but to a lesser multiplier than that of the conventional ADSL communications over twisted-pair 10A. For example, if the ratio of downstream to upstream communications over twisted-pair 10A is 6:1, the “reverse” ADSL facility over twisted-pair 10B may have a data rate of 3:1 (upstream: downstream); in this case, the sum of the data rates will be about 2:1 (downstream:upstream). It is contemplated that those skilled in the art having reference to this specification will be readily able to apply the desired frequency plan to the DSL facilities as appropriate for the desired transmission directionality ratio.

In any event, a common source and destination exists for the data that is transmitted and received over twisted-pairs 10A, 10B, according to this embodiment of the invention. For example, on the customer premises end of FIG. 2, customer computer 8 provides one or more data streams to CPE DSL modem 12, in response to which CPE DSL modem 12 splits the data streams (arbitrarily, if desired) into two data streams that are separately modulated and transmitted over twisted-pairs 10A, 10B; conversely, the two data streams that are received from twisted-pairs 10A, 10B are combined into data streams forwarded to customer computer 8, without regard to which twisted-pair 10A, 10B communicated which portions of the data. Similar combining and separating also preferably occurs on the CO side.

Still further in the alternative, it is contemplated that a particular customer may have a substantially greater demand for “upstream” bandwidth from the customer premises equipment CPE to central office CO, than it has for “downstream” bandwidth in the opposite direction. In this situation, communication may be carried out over only one of twisted-pairs 10A, 10B, using only the “reverse” frequency plan as shown in the example of FIG. 3B, in which the upstream traffic occupies frequency band FB3 and the downstream traffic occupies frequency band FB4. The DSL communications in this example is again asymmetric DSL (ADSL), but the asymmetry is reversed from the conventional modulation plan of FIG. 1 described above.

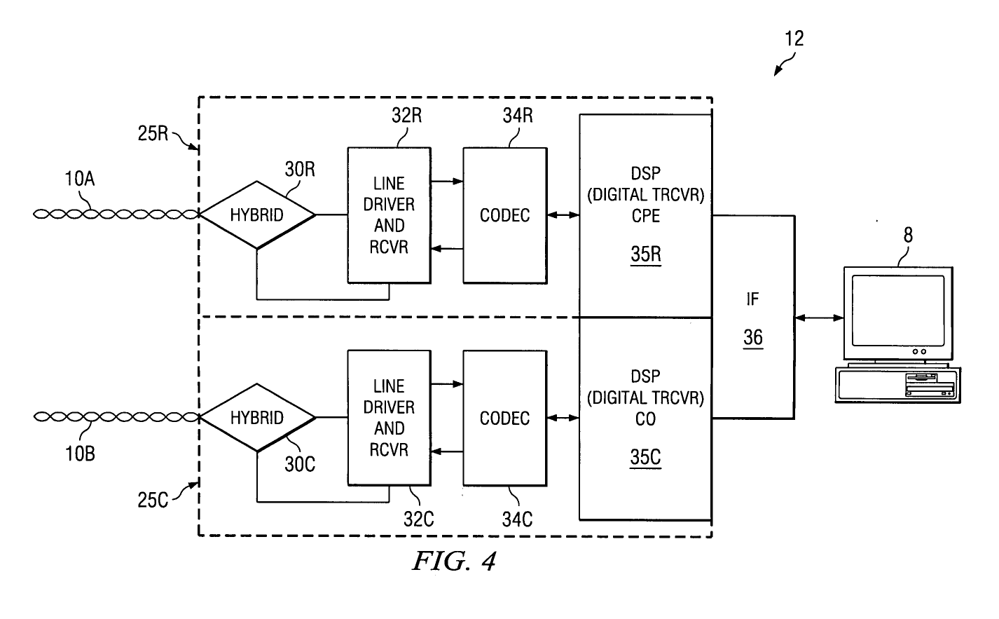

Referring now to FIG. 4, an example of the construction of CPE DSL modem 12 according to the preferred embodiment of the invention will now be described. In this embodiment of the invention, CPE DSL modem 12 includes a pair of transceivers 25R, 25C. Each of transceivers 25R, 25C are transceivers, in the sense that each can both transmit and receive signals. Transceivers 25R, 25C are connected to twisted-pairs 10A, 10B, respectively. Transceiver 25R, includes hybrid circuit 30R, connected to twisted-pair 10A. Hybrid circuit 30R is a conventional circuit that converts the two-wire arrangement of the twisted-pair facility to dedicated transmit and receive lines connected to line driver and receiver 32R, considering that bidirectional signals are communicated over twisted-pair 10A by CPE DSL modem 12. Line driver and receiver 32R is a high-speed line driver and receiver for driving and receiving ADSL signals over twisted-pair lines; an example of line driver and receiver 32R is the THS7102 line driver/receiver available from Texas Instruments Incorporated. Line driver and receiver 32R is bidirectionally coupled to coder/decoder (“codec”) circuit 34R, which carries out analog filtering, analog-to-digital conversion, and some amount of digital filtering, as conventional for CPE DSL modems in the art. According to the preferred embodiment of the invention, in which the ADSL communications are carried out according to a frequency division multiplexing (FDM) scheme as described above, codec circuit 34R filters the incoming downstream signal to eliminate any interference from the upstream signals that it is transmitting. An example of a suitable codec device may be selected from the TLV320AD1x device family available from Texas Instruments Incorporated. Hybrid circuit 30R, line driver and receiver 32R, and codec 34R are often referred to, in the aggregate, as an “analog front end”.

Transceiver 25R in CPE DSL modem 12 also includes DSP 35R, which serves as a digital transceiver for DSL communications. As noted above, DSP 35R is a high performance digital signal processor, for carrying out digital operations in response to program instructions. These digital operations include the encoding of the discrete multitone (DMT) modulated subchannels, for example according to the G.992.1 ADSL standard. Exemplary devices suitable for use as DSP 35R include DSPs having computational power similar to or greater than the TMS320c5x and TMS320c6x DSPs available from Texas Instruments Incorporated. A conventional host interface 36 couples DSP 35R to its customer computer 8, which may be a workstation or a network element, such as a router, in a local area network at the customer premises into which computer 8 is ultimately connected.

Transceiver 25R thus corresponds to a conventional CPE DSL modem, and carries out the appropriate modulation and demodulation of ADSL signals, according to the appropriate standard such as the G.992.1 standard mentioned above, in which the frequency plan corresponds to that illustrated in FIG. 3A described above. Transceiver 25R may be realized by way of a conventional CPE DSL modem chipset, a preferred example of which is the AR7 ADSL router and residential gateway chipset solution available from Texas Instruments Incorporated.

Transceiver 25C, on the other hand, corresponds to the functionality of a conventional central office ADSL modem, but is also implemented within CPE DSL modem 12. In other words, the “reverse” ADSL communications carried out by transceiver 25C over twisted-pair 10B include signals that are transmitted and received as though CPE DSL modem 12 were a CO modem. Accordingly, transceiver 25C is constructed similarly as transceiver 25R, including hybrid circuit 30C, line driver and receiver 32C, codec 34C, and digital transceiver 35C in the form of a DSP. Digital transceiver 35C may be implemented within the same DSP device as digital transceiver 35R, so long as this DSP has sufficient computational capacity and performance to handle transmission and receipt for both transceivers 25R, 25C. The functions of transceiver 25C differ from the corresponding functions of transceiver 25R, in that the frequency plan under which transceiver 25C operates allocates a higher data rate for the upstream transmission of data than for the receipt of downstream data, preferably in a complementary fashion relative to that of transceiver 25R. In the example in which transceiver 25R operates according to the frequency plan of FIG. 3A, transceiver 25C preferably operates according to the complementary frequency plan of FIG. 3B, to achieve full data rate symmetry.

Transceiver 25C may be implemented by way of a conventional central office ADSL modem chipset, deployed into CPE DSL modem 12. An example of such a CO chipset suitable for implementing transceiver 25C is the AC5 central office ADSL chipset available from Texas Instruments Incorporated. As mentioned above, construction of CPE DSL modem 12 may alternatively be arranged to take advantage of economies of scale, particularly by digital transceivers 35R, 35C both implemented within a common DSP.

FIG. 2B illustrates another system implementation into which the preferred embodiment of the invention may be implemented. In this example, central office CO (not shown) communicates with customer premises equipment CPE by way of twisted-pairs 10A, 10B as before. In this system implementation, however, central office CO includes a fiber optic transceiver, and as such the communicated data travels much of the distance between central office CO and customer premises equipment CPE over fiber optic facility FO. As known in the art, high-speed and high-volume communications are now often distributed over fiber optics, which provide high-frequency communication with greatly reduced signal attenuation and crosstalk relative to metal conductor wires. In the example of FIG. 2B, the fiber optic facility FO runs from central office CO to the service area. In this case fiber optic facility FO extends either directly, or via repeaters and other optical network elements as necessary (e.g., drop/add muxes), to concentrator 6, which is located at or near the customer premises. For example, in an FTTC system such as shown in FIG. 2B, concentrator 6 may be a “curb-side box” that serves one or more homes, or a similar “head-end” box in a building that serves multiple offices or apartments in that building. Typically, the distance between concentrator 6 and the CPE it serves is limited to a relatively short distance, such as on the order of 200 to 300 meters.

Concentrator 6, according to this embodiment of the invention, may be realized in any one of a number of functional units. In the form of a service area concentrator (“SAC”), concentrator 6 has the appropriate functionality to permit one or more upstream paths (carried on one or more fiber optic facilities FO) to service a higher number of lower-speed channels, for example by managing channel contentions and by providing the appropriate buffering when necessary. According to this particular embodiment of the invention, concentrator 6 includes Digital Subscriber Line Access Multiplexer (“DSLAM”) 2′ (or alternatively, a cross-connect switch) for coupling signals from fiber optic facility FO to the appropriate subscriber, such as that associated with DSL modem 12 to which connection is made by twisted-pairs 10A, 10B. Other types of functional units or optical network units (ONUs) may also realize the function of concentrator 6 according to this embodiment of the invention. As will be apparent from this specification, concentrator 6 will have knowledge of the subscriber loops that it is servicing, and of the service providers for those subscribers.

DSLAM 2′ in concentrator 6 of FIG. 2B performs much of the signal processing that is performed at central office CO in the example of FIG. 2A. In this example, on the “upstream” side, DSLAM 2′ includes receiver and analog-to-digital converter circuitry for converting received incoming signals from DSL modem 12, over twisted-pairs 10A, 10B as described above, into digital bitstreams. According to this embodiment of the invention, DSLAM 2′ includes circuitry for demodulating the digital bitstreams from the DMT modulated signals into baseband data; coder/decoder (“codec”) circuitry for decoding this data. DSLAM 2′ further preferably includes the appropriate conventional transceiver circuitry for driving fiber optic facility FO according to the received, demodulated, and decoded upstream DSL communications; the particular communications standard according to which DSLAM 2′ applies these signals to fiber optic facility FO can be any one of various conventional standards, including Internet Protocol (IP), Asynchronous Transfer Mode (ATM), and the like, with the physical layer standards corresponding to conventional SONET optical transmissions. On its “downstream” side, DSLAM 2′ effects the reverse operation, using codec circuitry in the digital domain to encode the received IP or ATM signals from fiber optic facility FO, modulation circuitry to generate DMT modulated digital signals according to the preferred embodiment of the invention (e.g., in frequency bands FB2 and FB4), which are then converted by digital-to-analog converter circuitry and driven on twisted-pairs 10A, 10B by line driver circuitry.

It is believed that the implementation of FIG. 2B will provide improved performance over the system implementation of FIG. 2A, because of the long portion of the loop length that is implemented by fiber optic facility FO rather than twisted-pairs 10A, 10B. Indeed, the DSL service provided by the implementation of FIG. 2B is not limited to relatively short loop lengths (e.g., currently limited to about 18 kft); rather, the fiber optic facility FO permits the distance between the central office CO and concentrator 6 to be arbitrarily long. In addition, the provision of localized digital signal processing, for example at DSLAM 2′ within concentrator 6 in a curb-side box, further improves the efficiency with which the overall communications can take place. Of course, these performance advantages require the deployment of the DSLAM and digital circuitry in the field, near the customer premises.

Referring now to FIG. 2C, the arrangement of another implementation of a DSL communication system according to the preferred embodiment of the invention, will now be described. The realization of FIG. 2C provides central office CO similar to that in FIG. 2A, with cross-connect switch 2 switching, terminating, and interconnecting of subscriber lines, trunks, and loops in the conventional manner. According to this embodiment of the invention, modulator/demodulator (“modem”) functionality is preferably implemented within cross-connect switch 2, at the central office CO. Central office CO also contains fiber optic transmitter/receiver 4, which applies signals to and receives signals from fiber optic facility FO.

In this exemplary system of FIG. 2C, fiber optic facility FO runs from central office CO directly, or via repeaters and other optical network elements as necessary (e.g., drop/add muxes), to concentrator 6′ at a “curb-side box”, building “head-end”, or the like. In this example, concentrator 6′ includes line driver/receiver and analog to digital converter circuitry, for receiving analog upstream DMT signals from twisted-pairs 10A, 10B according to the frequency plan described above, and for converting these signals into digital bitstreams that are also DMT modulated and applied to fiber optic facility FO. Conversely, on the downstream side, concentrator 6′ includes the appropriate circuitry for receiving DMT modulated signals from fiber optic facility FO, and converting these signals to analog DMT modulated signals for application to twisted-pairs 10A, 10B according to the frequency plan of the invention and described above. Concentrator 6′ also will have knowledge of the subscriber loops that it is servicing, and of the service providers for those subscribers.

In this example of the preferred embodiment of the invention, the DMT modulator and demodulator (“modem”) functionality resides at the central office (CO), as in the case of FIG. 2A. But this particular installation also provides the advantage of overcoming the distance limitation between central office CO and customer premises equipment CPE, because of its use of fiber optic facility FO. This particular deployment also reduces the digital signal processing circuitry and functionality that is installed in the field in curb-side boxes and the like, relative to the example of FIG. 2B.

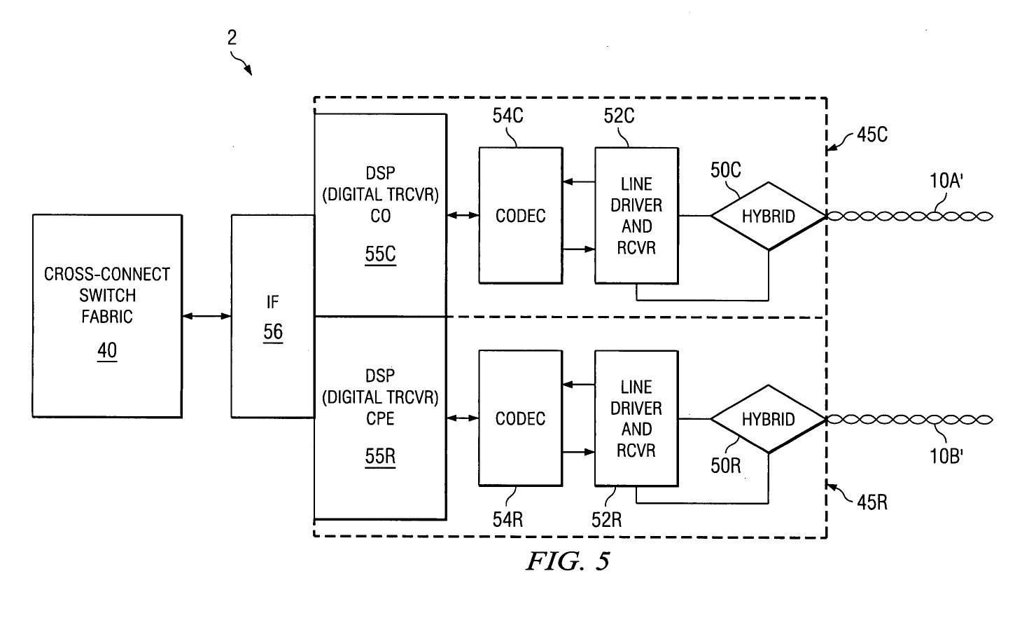

FIG. 5 illustrates the construction of cross-connect switch 2 of FIGS. 2A and 2C, including central office ADSL modem functionality, according to the preferred embodiment of the invention. For the example of FIG. 2B, the functionality of cross-connect switch 2 will be implemented in DSLAM 2′ in concentrator 6, as described above. It is contemplated that those skilled in the art having reference to this specification will be readily able to modify this particular architecture in a manner suitable for such curb-side box implementation. In any case, this exemplary construction is illustrated for two modem “ports”, it being understood that many more such ports will be implemented in switch 2 at a typical central office.

In the example of FIG. 5, switch 2 contains cross-connect switch fabric 40, which refers to conventional circuitry and systems for implementing the functions of a typical CO switch. Switch fabric 40 is bidirectionally coupled to host interface 56, which is conventional circuitry that provides an interface for the baseband data communicated to and from switch fabric 40 and ADSL modem functionality. Switch fabric 40 in turn is interfaced to the public switched telephone network, or to another large-scale network (such as the Internet). According to this embodiment of the invention, similar to CPE DSL modem 12, switch 2 contains complementary ADSL modem functionality, including conventional CO ADSL transceiver 45C and also complementary ADSL transceiver 45R, which operates as a conventional CPE ADSL transceiver but is deployed at the CO.

Accordingly, as shown in FIG. 5, CO transceiver 45C includes conventional functionality for a CO ADSL modem, including hybrid circuit 50C, line driver and receiver 52C, codec 54C, and digital transceiver 55C, which is preferably in the form of a DSP. Hybrid circuit 50R is illustrated as connected to twisted-pair 10A′, which corresponds to twisted-pair 10A connected to CPE DSL modem 12 in this preferred embodiment of the invention. Of course, twisted-pair 10A′ will typically not be the same physical twisted-pair wires as twisted-pair 10A at CPE DSL modem 12. For example, as shown in FIG. 2, it is contemplated that switch 2 will be connected to CPE DSL modem 12 by way of concentrator 6, intermediate fiber optic facility FO, as well as fiber optic transmitter/receiver 4 and other network units in the overall system. Indeed, the output of hybrid circuit 50C may not be a twisted-pair wire facility, depending upon the particular implementation of switch 2. The designation of twisted-pair 10A′ in FIG. 5 is intended to illustrate that transceiver 45C transmits and receives signals that are eventually carried over twisted-pair 10A, upon the initiation of a DSL communication session with CPE modem 12. Transceiver 45C preferably operates according to conventional ADSL communications standards, transmitting downstream traffic at a much higher data rate than the data rate of the upstream traffic that it receives, for example according to a frequency plan as shown in FIG. 3A. As mentioned above, a conventional CO ADSL modem chipset may be used to implement transceiver 45C, an example of which is the AC5 octal-port central office ADSL chipset available from Texas Instruments Incorporated.

According to the preferred embodiment of the invention, transceiver 45R is also provided at switch 2, and operates similarly as a conventional CPE modem but is deployed at the central office. Accordingly, transceiver 45R includes the ADSL modem functions of hybrid circuit 50R, line driver and receiver 52R, codec 54R, and digital transceiver 55R, which is preferably also in the form of a DSP (and which may share the same DSP as digital transceiver 55C, if sufficient computational capacity and performance is present). Hybrid circuit 50R of transceiver 45R is coupled to twisted-pair 10B′, which corresponds to twisted-pair 10B at CPE DSL modem 12; as before, it is contemplated that many intermediate elements, such as fiber optic transmitter/receiver 4, fiber optic facility FO, and concentrator 6 will be present between transceiver 45R and CPE DSL modem 12, and as such twisted-pair 10B′ may in fact not be a twisted-pair of wires, depending on the implementation. It is contemplated that a conventional ADSL modem chipset, for example the AR7 chipset available from Texas Instruments Incorporated, may be used to realize transceiver 45R. As mentioned above, digital transceivers 55C, 55R may be able to share the same DSP device.

In any event, transceiver 45R operates in a complementary manner relative to transceiver 45C, in that it receives and processes upstream communications at a higher data rate than the downstream communications that it transmits over twisted-pair 10B′. Preferably, the operation of transceiver 45R is complementary to that of transceiver 45C, so that the sum of the upstream and downstream data rates handled by transceivers 45R, 45C are substantially symmetric. For example, if transceiver 45C operates according to the frequency plan of FIG. 3A, transceiver 45R preferably operates according to the complementary frequency plan of FIG. 3B.

Referring back to FIGS. 2A through 2C and 4, and as evident from the foregoing description, twisted-pairs 10A, 10B are preferably contained in the same binder group, and can carry traffic in opposing directions as one another, for each frequency in the available spectrum. As such, the potential for near-end crosstalk (“NEXT”) is present according to this embodiment of the invention; as mentioned above, the FDM approach used by conventional ADSL substantially eliminates NEXT.

According to the preferred embodiment of the invention, therefore, various crosstalk mitigation techniques are preferably implemented, for example at CPE DSL modem 12 and at CO switch 2 for the examples of FIGS. 2A and 2C, or at DSLAM 2′ for the example of FIG. 2B. Preferably, the power spectral density (PSD) is constrained for the “reverse” ADSL communications carried out between transceiver 25C at CPE DSL modem 12 and transceiver 45R at switch 2 to a level corresponding to the T1.417 spectral compatibility standard. In this event, the crosstalk generated by this “reverse” ADSL communications is at a level that is no worse than conventional HDSL and SHDSL communications, and which is therefore suitable for high-data rate communications. In addition, or alternatively, crosstalk mitigation schemes such as echo cancellation using a conventional multiple-input multiple-output (“MIMO”) technique may be implemented at CPE DSL modem 12 and switch 2.

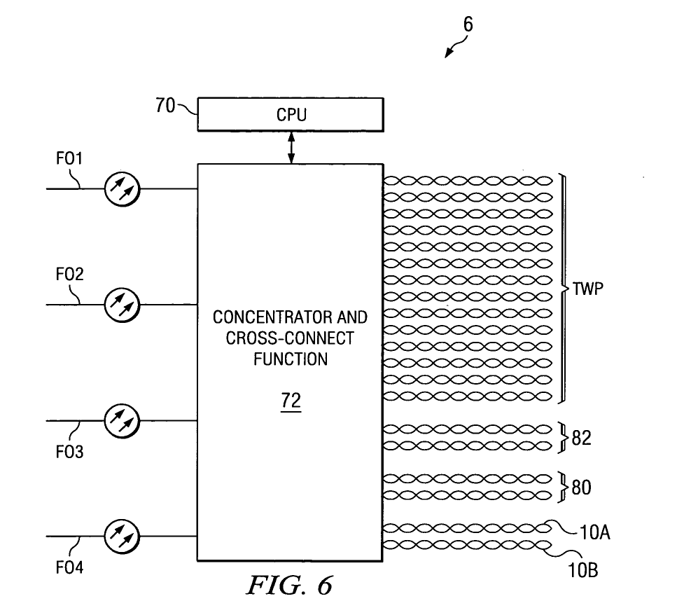

To further suppress crosstalk in the symmetric ADSL communications according to the preferred embodiment of the invention, intermediate elements such as cross-connect cabinets, optical network units, and service area concentrators can assist in the management of the bundled complementary twisted-pair facilities. Referring now to FIG. 6, the construction of concentrator 6 according to the preferred embodiments of the invention, and incorporating functionality for managing these facilities, will now be described. Concentrator 6′ of FIG. 2C will be similarly constructed, but will also include the functionality of DSLAM 2′ as described above.

As shown in FIG. 6, concentrator 6 includes concentrator and cross-connect function 72, which in this example is coupled on the downstream side to twisted-pairs 10A, 10B, which are within a common binder or binder group and which carry complementary ADSL traffic as described above, and to also binders 80, 82 that each include at least two twisted-pairs for similarly carrying complementary ADSL traffic. Concentrator and cross-connect function 72 is also connected to many other twisted-pairs TWP, which are arranged in binder groups according to the particular implementation. On the upstream side, concentrator and cross-connect function 72 is coupled to one or more fiber optic facilities FO; in this example, four fiber optic facilities FO1 through FO4 are coupled to concentrator and cross-connect function 72. Accordingly, this example of concentrator 6 corresponds to a concentrator that is also an optical network unit (ONU), as evident from FIGS. 2B and 2C. Alternatively, concentrator 6 may receive twisted-pair wires on the upstream side also, depending upon its particular deployment. In any case, various interface circuitry and functionality is therefore realized within concentrator and cross-connect function 72, as conventional in the art.

According to this embodiment of the invention, concentrator 6 also includes CPU 70, which controls the operation of concentrator and cross-connect function 72, for example in response to an operational program or settings that are communicated to CPU 70. In this embodiment of the invention, CPU 70 controls concentrator and cross-connect function 72 according to knowledge of the various service providers that particular subscribers utilize. For example, according to this preferred embodiment of the invention, twisted-pairs 10A, 10B are connected to CPE in which the complementary symmetric ADSL communications are carried out, as described above. This communication is of course forwarded back to the CO for that service provider, which includes transceivers 45C, 45R that communicate in this complementary fashion. Accordingly, CPU 70 ensures that the binder group containing twisted-pairs 10A, 10B are reserved for that service provider for that subscriber. In this way, crosstalk mitigation techniques at the CO and at the CPE can be effective under the control and operation of that service provider. Crosstalk interference from other service providers that do not utilize the complementary symmetric ADSL approach of this invention, nor the crosstalk mitigation techniques, can therefore be kept out of the binder group associated with twisted-pairs 10A, 10B. Twisted-pair wire pairs 80, 82 can similarly be controlled by CPU 70 and concentrator and cross-connect function 72, to provide complementary ADSL service by the same provider as that of twisted-pairs 10A, 10B, or by another provider (which may use different crosstalk mitigation techniques). Twisted-pairs TWP may be similarly arranged, or may be used to carry out conventional ADSL communications.

According to the preferred embodiment of the invention, therefore, important advantages in digital communications can be attained. Subscribers that demand more symmetric upstream and downstream data rates can be served, according to this invention, by the use of existing infrastructure and technology in providing complementary ADSL communications on adjacent twisted-pairs in the same binder group. In many cases, unused wire pairs in existing telephone installations are available to carry the complementary “reverse” ADSL communications from the subscriber premises. The realization of these symmetric ADSL communications can be readily implemented, without requiring widespread installation of new equipment according to a different DSL standard.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A digital subscriber line modem, comprising:
a first transceiver, adapted to be coupled to a first communications facility, for modulating and transmitting signals in a first frequency band over the first communications facility, and for receiving and demodulating signals in a second frequency band from the first communications facility, wherein the data rate of the signals received by the first transceiver is significantly higher than that of the signals transmitted by the first transceiver;
a second transceiver, adapted to be coupled to a second communications facility, for modulating and transmitting signals in a third frequency band over the second communications facility, and for receiving and demodulating signals in a fourth frequency band from the second communications facility, wherein the data rate of the signals transmitted by the second transceiver is significantly higher than that of the signals received by the second transceiver;
a host interface coupled to the first and second transceivers, for outputting the demodulated received signals from the first and second transceivers, and for receiving the signals to be modulated and transmitted by the first and second transceivers.

2. The modem of claim 1, wherein the first and second communications facilities comprise first and second twisted-wire pairs.

3. The modem of claim 2, wherein the first and fourth frequency bands are substantially identical.

4. The modem of claim 3, wherein the second and third frequency bands are substantially identical.

5. The modem of claim 2, wherein the first and second frequency bands do not overlap;
and wherein the second frequency band covers higher frequencies than the first frequency band.

6. The modem of claim 5, wherein the third and fourth frequency bands do not overlap;
and wherein the third frequency band covers higher frequencies than the fourth frequency band.

7. The modem of claim 1, wherein each of the first and second transceivers comprise:
a hybrid circuit, coupled to the communications facility;
a line driver and receiver circuit, coupled to the hybrid circuit;
a coder/decoder, coupled to the line driver and receiver circuit; and
a digital transceiver, coupled between the coder/decoder and the host interface.

8. The modem of claim 7, wherein the digital transceivers of the first and second transceivers comprise a digital signal processor.

9. A digital subscriber line communications system, comprising:
a communications facility, comprising:
a first twisted-wire pair;
a second twisted-wire pair;
a central office modem, comprising:
a. first transceiver, for receiving and demodulating signals in a first frequency bandover the first twisted-wire pair, and for modulating and transmitting signals in a second frequency band over the first twisted-wire pair, wherein the data rate of the signals received by the first transceiver is significantly lower than that of the signals transmitted by the first transceiver;
a second transceiver, for receiving and demodulating signals in a third frequency band over the second twisted-wire pair, and for modulating and transmitting signals in a fourth frequency band over the second twisted-wire pair, wherein the data rate of the signals received by the second transceiver is significantly higher than that of the signals transmitted by the second transceiver;
a network interface, for interfacing the first and second transceivers to a network;
a customer premises equipment modem associated with a customer, comprising:
a third transceiver, for modulating and transmitting signals in the first frequency band over the first twisted-wire pair, and for receiving and demodulating signals in the second frequency band over the first twisted-wire pair, wherein the data rate of the signals received by the third transceiver is significantly higher than that of the signals transmitted by the third transceiver;
a fourth transceiver, for modulating and transmitting signals in the third frequency band over the second twisted-wire pair, and for receiving and demodulating signals in the fourth frequency band over the second twisted-wire pair, wherein the data rate of the signals transmitted by the second transceiver is significantly higher than that of the signals received by the second transceiver; and
a host interface, for interfacing the third and fourth transceivers to a network.

10. The system of claim 9, further comprising:
a communications facility, coupled to the first and second transceivers of the central office modem; and
a concentrator, coupled to the first and second twisted-wire pairs and to the communications facility.

11. The system of claim 10, wherein the communications facility comprises a fiber optic facility.

12. The system of claim 11, wherein the concentrator comprises:
analog-to-digital converter circuitry, for converting analog signals received over the first and second twisted-wire pairs to digital signals; and
digital-to-analog converter circuitry, for converting digital signals into analog signals for transmission over the first and second twisted-wire pairs.

13. The system of claim 12, wherein the concentrator further comprises:
modulator and demodulator circuitry, for modulating and demodulating signals communicated between the communications facility and the first and second twisted-wire pairs, so that the signals communicated over the first and second twisted-wire pairs are modulated according to a discrete multi-tone modulation.

14. The system of claim 10, wherein the communications facility comprises wire conductors.

15. The system of claim 9, wherein the first and fourth frequency bands are substantially identical.

16. The system of claim 15, wherein the second and third frequency bands are substantially identical.

17. The system of claim 9, wherein the first and second frequency bands do not overlap;
and wherein the second frequency band covers higher frequencies than the first frequency band.

18. The system of claim 17, wherein the third and fourth frequency bands do not overlap;
and wherein the third frequency band covers higher frequencies than the fourth frequency band.

19. The system of claim 10, wherein the concentrator comprises:
a concentrator function, coupled to the first and second twisted-wire pairs and to the communications facility; and
a central processing unit, coupled to the concentrator function, for assigning the first and second twisted-wire pairs to a communications service provider associated with the customer serviced by the first and second twisted-wire pairs.

20. The system of claim 9, wherein the first and second twisted-wire pairs are disposed within a common sheath.

21. A method of communicating digital data over first and second twisted-wire pairs, comprising:
modulating digital data over a plurality of subchannels within a first frequency band to produce a first signal stream;
transmitting the first signal stream over a first twisted-wire pair;
receiving a second signal stream over the first twisted-wire pair;
demodulating digital data from the second signal stream, the demodulated digital data corresponding to a plurality of subchannels within a second frequency band;
wherein the data rate of the digital data demodulated from the second signal stream is substantially higher than that of the digital data modulated over the plurality of subchannels within the first frequency band;
modulating digital data over a plurality of subchannels within a third frequency band to produce a third signal stream;
transmitting the third signal stream over a second twisted-wire pair;
receiving a fourth signal stream over the second twisted-wire pair;
demodulating digital data from the fourth signal stream, the demodulated digital data corresponding to a plurality of subchannels within a fourth frequency band;
wherein the data rate of the digital data demodulated from the fourth signal stream is substantially less than that of the digital data modulated over the plurality of subchannels within the third frequency band; and
outputting the demodulated digital data from the second and fourth signal streams to a destination.

22. The method of claim 21, wherein the first and fourth frequency bands are substantially identical.

23. The method of claim 22, wherein the second and third frequency bands are substantially identical.

24. The method of claim 21, wherein the first and second frequency bands do not overlap;
and wherein the second frequency band covers higher frequencies than the first frequency band.

25. The system of claim 24, wherein the third and fourth frequency bands do not overlap;
and wherein the third frequency band covers higher frequencies than the fourth frequency band.

26. A digital subscriber line communications system, comprising:
a communications facility comprising a twisted-wire pair;
a central office modem, comprising:
a CO transceiver for receiving and demodulating signals in a first frequency band over the communications facility, and for modulating and transmitting signals in a second frequency band over the communications facility, wherein the data rate of the signals received by the CO transceiver is significantly higher than that of the signals transmitted by the CO transceiver;
a network interface, for interfacing the CO transceiver to a network; and
a customer premises equipment modem, comprising:
a CPE transceiver, coupled to the twisted-wire pair, for modulating and transmitting signals in the first frequency band over the twisted-wire pair, and for receiving and demodulating signals in the second frequency band over the twisted-wire pair, wherein the data rate of the signals transmitted by the CPE transceiver is significantly higher than that of the signals received by the CPE transceiver;
a host interface, for interfacing the CPE transceiver to a network.
